(19) United States
(12) Patent Application Publication
(10) Pub. No.: US 2001/0044500 A1
(43) Pub. Date: Nov. 22, 2001

(54) Fluoroelastomer composition

(75) Inventor: Satoru Saito, Kitaibaraki-shi (JP)

Correspondence Address: Russell D. Orkin, 700 Koppers Building, 436 Seventh Avenue, Pittsburgh, PA, 15219-1818, US

(73) Assignee: NIPPON MEKTRON, LTD.

(21) Appl. No.: 09/836,801

(22) Filed: Apr. 17, 2001

(30) Foreign Application Priority Data
Apr. 18, 2000 (JP) 2000-116907
Mar. 14, 2001 (JP) 2001-72948

(51) Int. Cl. C08F 14/18

(52) U.S. Cl. 525/326.3; 525/333.6

(57) ABSTRACT

Disclosed is a fluoroelastomer composition comprising (1) a fluoroelastomer which comprises tetrafluoroethylene, a perfluoro (C₁-C₅ alkyl vinyl ether) or a perfluoro (C₃-C₁₁ (alkoxyalkyl) vinyl ether) and a cyano group-containing perfluorovinyl ether, (2) a hydrotalcite compound, (3) a crosslinking agent and (4) carbon black. The fluoroelastomer composition has excellent metal corrosion inhibition properties, and particularly, this composition generates only small amount of a corrosive material when exposed to high temperatures.

### FIELD OF THE INVENTION

The present invention relates to a fluoroelastomer composition, and more particularly to a fluoroelastomer composition having excellent metal corrosion inhibition properties.

### BACKGROUND OF THE INVENTION

In Japanese Patent Laid-Open Publication No. 120144/1996, there is described a fluoroelastomer composition comprising a terpolymer of tetrafluoroethylene, a perfluoro (alkyl vinyl ether) and a cyano group-containing perfluorovinyl ether represented by the formula CF₂=CFO(CF₂)ₙOCF(CF₃)CN (n: 2-5) and as a crosslinking agent a bis(aminophenyl) compound represented by the following formula:

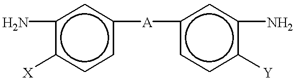

wherein A is an alkylidene group of 1 to 6 carbon atoms or a perfluoroalkylidene group of 1 to 10 carbon atoms, and X and Y are each a hydroxyl group or an amino group.

In Japanese Patent Laid-Open Publication No. 31284/1997, there is described a fluoroelastomer composition comprising a terpolymer of tetrafluoroethylene, a perfluoro (alkyl vinyl ether) and a cyano group-containing perfluorovinyl ether and as a crosslinking agent a bisamidoxime compound represented by the following formula:

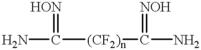

wherein n is an integer of 1 to 10.

In this connection, it is preferable to add carbon black to the crosslinking fluoroelastomer compositions, whereby molded articles of the compositions can be enhanced in the mechanical properties.

Molded products produced from a crosslinking fluoroelastomer composition comprising a terpolymer of tetrafluoroethylene, a perfluoro (C₁-C₅ alkyl vinyl ether) and a cyano group-containing perfluorovinyl ether, a crosslinking agent and carbon black generally have very excellent heat resistance, solvent resistance and mechanical properties, so that they are used for chemical industry, aerospace industry, semiconductor industry, etc.

However, when the above fluoroelastomer molded products are in contact with metals, the contact areas of the metals with the molded products are sometimes corroded depending upon the conditions.

Especially under the high-temperature conditions, the molded products undergo thermal degradation to generate a corrosive material, and the corrosive material sometimes corrodes the metal surfaces.

To a fluoroelastomer, metallic oxides, such as calcium hydroxide, magnesium oxide, zinc oxide and lead oxide, are generally added in order to inhibit generation of a corrosive material during the processing stage or the practical use.

However, even if the metallic oxides are added to the fluoroelastomer, corrosion of metals during the practical use cannot be inhibited. Moreover, calcium hydroxide, magnesium oxide and zinc oxide sometimes induce deterioration of solvent resistance such as hot water resistance.

### OBJECT OF THE INVENTION

It is an object of the present invention to provide a fluoroelastomer composition having excellent metal corrosion inhibition properties, and more particularly, it is an object of the invention to provide a fluoroelastomer composition which generates only small amount of a corrosive material when it is exposed to high temperatures.

### SUMMARY OF THE INVENTION

The fluoroelastomer composition according to the invention comprises:

(1) a fluoroelastomer comprising:

(i) tetrafluoroethylene,

(ii) a perfluoro (C₁-C₅ alkyl vinyl ether) or a perfluoro (C₃-C₁₁ (alkoxyalkyl) vinyl ether), and

(iii) a cyano group-containing perfluorovinyl ether,

(2) a hydrotalcite compound,

(3) a crosslinking agent, and

(4) carbon black.

### DETAILED DESCRIPTION OF THE INVENTION

The fluoroelastomer composition according to the invention is described in detail hereinafter.

The fluoroelastomer for use in the invention is a terpolymer of tetrafluoroethylene, a perfluoro(C₁-C₅ alkyl vinyl ether) or a perfluoro (C₃-C₁₁ (alkoxyalkyl) vinyl ether) and a cyano group-containing perfluorovinyl ether.

As the fluoroelastomer, preferably used is one obtained by copolymerizing 50 to 75% by mol, preferably 60 to 75% by mol, of the tetrafluoroethylene, 49.8 to 25% by mol, preferably 39.8 to 25% by mol, of the perfluoro (alkyl vinyl ether) or the perfluoro(alkoxyalkyl vinyl ether), and 0.2 to 5% by mol, preferably 0.5 to 2% by mol, of the cyano group-containing perfluorovinyl ether.

### Perfluoro (C₁-C₅ alkyl vinyl ether), Perfluoro (C₃-C₁₁ (alkoxyalkyl) vinyl ether)

Examples of the perfluoro (C₁-C₅ alkyl vinyl ethers) used herein include perfluoro (methyl vinyl ether), perfluoro (ethyl vinyl ether) and perfluoro (propyl vinyl ether). Of these, perfluoro (methyl vinyl ether) is preferably employed.

Examples of the perfluoro (C₃-C₁₁ (alkoxyalkyl) vinyl ethers) include compounds represented by the following formulas. The number of carbon atoms represented by C₃-C₁₁ means a sum of carbon atoms in a group bonded to the vinyl ether group (CF₂=CFO).

| | |
|---|---|
| CF₂═CFOCF₂CF(CF₃)OCₙF₂ₙ₊₁ | (n: 1-5) |
| CF₂═CFO(CF₂)₃OCₙF₂ₙ₊₁ | (n: 1-5) |
| CF₂═CFOCF₂CF(CF₃)O(CF₂O)ₘCₙF₂₊₁ | (n: 1-5, m: 1-3) |
| CF₂═CFO(CF₂)₂OCₙF₂ₙ₊₁ | (n: 1-5) |

### Cyano group-containing perfluorovinyl ether

The cyano group-containing perfluorovinyl ether provides crosslinked site unit, and for example, a compound represented by the following formula is employed.

| | |
|---|---|
| CF₂═CFO(CF₂)ₙOCF(CF₃)CN | (n: 2-4) |

Other examples employable in the invention include:

a compound represented by the following formula:

| | |
|---|---|
| CF₂═CFO(CF₂)ₙCN | (n: 2-12) |

(that is described in U.S. Pat. No. 3,546,186);

a compound represented by the following formula:

| | |
|---|---|
| CF₂═CFO(CF₂CF(CF₃)O)ₘ(CF₂)ₙCN | (n: 2, m: 1-5) |

(that is described in U.S. Pat. No. 4,138,426);

a compound represented by the following formula:

| | |
|---|---|
| CF₂═CFO(CF₂CF(CF₃)O)ₘ(CF₂)ₙCN | (n: 1-4, m: 1-2) |

(that is described in U.S. Pat. No. 4,281,092);

and

a compound represented by the following formula:

| | |
|---|---|
| CF₂═CFO(CF₂CF(CF₃)O)ₙCF₂CF(CF₂)CN | (n: 0-4) |

(that is described in U.S. Pat. No. 3,852,326 and U.S. Pat. No. 3,933,767).

### Hydrotalcite compound

The hydrotalcite compound is a compound represented by the formula (Mg)ₓ(R)_{y}(OH)_{z}CO₃·nH₂O (R: Al, Cr or Fe, x: 4-6, y: 2, z: 12-18, n:0-4)

As the hydrotalcite compound, a compound represented by the formula Mg_{4.5}Al₂(OH)₁₃CO₃·3.5H₂O is preferably employed.

A compound obtained by calcining the above compound to remove water of crystallization is also employable.

The hydrotalcite compound is used in an amount of 0.1 to 10 parts by weight, preferably 0.5 to 5 parts by weight, based on 100 parts by weight of the fluoroelastomer.

If the amount of the hydrotalcite compound is too small, satisfactory metal corrosion inhibition properties cannot be obtained. If the amount thereof is too large, deterioration of heat resistance of the fluoroelastomer composition is induced.

### Crosslinking agent

As the crosslinking agent, a compound represented by the following formula (I) or (II) is employed.

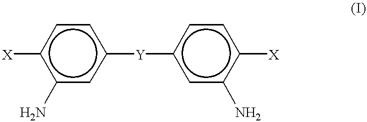

wherein Y is a C₁-C₆ alkylidene group, a C₁-C₁₀ perfluoroalkylidene group, a —SO₂— group, an —O— group, a —C(=O)— group or a carbon-carbon bond to directly bond two benzene rings, and X is a hydroxyl group or an amino group.

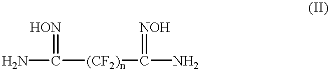

wherein n is an integer of 1 to 10.

A compound represented by the following formula (III) or (IV) is also employable.

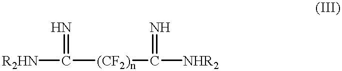

wherein R₂ is H or NH₂, and n is an integer of 1 to 10.

For example, there can be mentioned compounds represented by the following formulas.

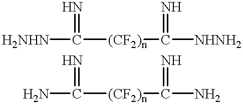

In the above formulas, n is an integer of 1 to 10.

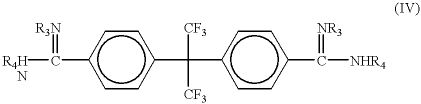

wherein R₃ is OH or H, and R₄ is H or NH₂.

For example, there can be preferably mentioned compounds represented by the following formulas.

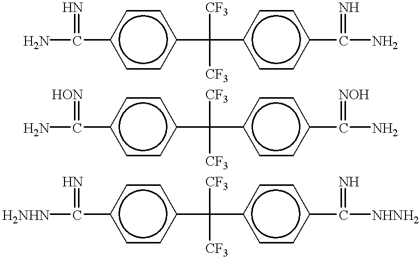

### Carbon black

As the carbon black, carbon black of N-110 to N-990 is employable in the invention, and the carbon black is used in an amount of 1 to 30 parts by weight, preferably 2 to 20 parts by weight, based on 100 parts by weight of the fluoroelastomer.

To the fluoroelastomer composition containing the above components as essential components, other components such as a processing aid can be appropriately added if necessary.

The composition can be prepared by, for example, mixing the above components at a temperature of 20 to 100° C., preferably 30 to 80° C., using a two-roll mill.

The composition can be molded into a desired shape such as a shape of o-ring by means of a compression molding machine or the like. The molding temperature is in the range of 150 to 250° C., preferably 170 to 220° C., and the molding time is in the range of 5 to 60 minutes, preferably 5 to 30 minutes.

To enhance the properties of the molded article, it is preferable to subject the molded product of the composition to oven vulcanization in an inert atmosphere at a vulcanization temperature of 150 to 320° C., preferably 200 to 300° C., for a vulcanization time of 10 to 50 hours.

### Effect Of The Invention

The fluoroelastomer composition of the invention provides a vulcanized molded product having excellent metal corrosion inhibition properties.

The composition of the invention is favorably applied particularly to uses where the composition is in contact with a metal and is exposed to severe conditions such as temperature conditions of not lower than 150° C.

The molded product of the composition has excellent chemical resistance, and hence it also exhibits sufficient resistance to severe environment where various conditions such as contact with metals, high temperature and highly reactive liquids complicatedly act on the molded product.

### EXAMPLE

### Example 1, Comparative Examples 1-4

Preparation of composition

100 Parts by weight of the following fluoroelastomer A, the following crosslinking agent and compounding additives shown in Table 1 were kneaded at a temperature of 40 to 60° C. using a two-roll mill to obtain a composition.

Fluoroelastomer A

| | |
|---|---|
| Tetrafluoroethylene | 68.4% by mol |
| Perfluoro (methyl vinyl ether) | 30.5% by mol |
| Perfluoro (2-cyano-3,7-dioxa-8-nonene) | 1.1% by mol |
| *Polymer Mooney Viscosity (at 150° C.) | 61.1 pts |

Crosslinking agent I

2,2-Bis(3-amino-4-hydroxyphenyl)hexafluoropropane The composition obtained above was subjected to compression molding to obtain a desired crosslinked product. The crosslinked product was then subjected to oven vulcanization in a nitrogen atmosphere under the following conditions.

The oven vulcanization was carried out, first, at 90° C. for 4 hours, then with a temperature rise from 90° C. to 204° C. over a period of 6 hours, then at 204° C. for 18 hours, then with a temperature rise from 204° C. to 288° C. over a period of 6 hours, and finally at 288° C. for 18 hours.

The compounding additives are as follows.

Hydrotalcite compound: DHT-4A™, available from Kyowa Kagaku

Calcium hydroxide: Caldic 2000, available from Omi Kagaku

Magnesium oxide: MgO 150, available from Kyowa Kagaku

Zinc oxide: Zinc White No. 1, available from Sakai Kagaku

Carbon black :SAF SEAST 9, available from Tokai Carbon

The product obtained above was subjected to the following tests.

Cured product property test

Hardness: DIN53505

Tensile test: DIN53503

Compression set: ASTM D395, Method B (214 O-ring)

Corrosion test

Between metal plates (each: 50×50×2 mm), a 214 O-ring was sandwiched, and they were compressed by 3% of the linear diameter of the O-ring.

The metal plates and the O-ring in the above state were heated in an oven at 250° C. for 70 hours. After the heating, the metal plates were separated from the O-ring, and corrosion of the metal portion formerly sealed with the O-ring was visually observed with the naked eyes.

The results are set forth in Table 1.

### Example 2. Comparative Example 5

Preparation of composition

100 Parts by weight of the following fluoroelastomer B, the following crosslinking agent and compounding additives shown in Table 2 were kneaded at a temperature of 40 to 60° C. using a two-roll mill to obtain a composition.

Fluoroelastomer B

| | |
|---|---|
| Tetrafluoroethylene | 71.5% by mol |
| Perfluoro (methyl vinyl ether) | 27.7% by mol |
| Perfluoro (1-cyano-6-oxa-7-octene) | 0.8% by mol |
| *Polymer Mooney Viscosity (at 150° C.) | 73.9 pts |

Crosslinking agent II

2,2,3,3,4,4,5,5-octafluorohexanediamidoxime The composition obtained above was subjected to compression molding to obtain a desired crosslinked product. The crosslinked product was then subjected to oven vulcanization in a nitrogen atmosphere under the following conditions.

The oven vulcanization was carried out, first, at 90° C. for 4 hours, then with a temperature rise from 90° C. to 204° C. over a period of 6 hours, then at 204° C. for 18 hours, then with a temperature rise from 204° C. to 288° C. over a period of 6 hours, and finally at 288° C. for 18 hours.

The compounding additives are as follows.

Hydrotalcite compound: DHT-4A™, available from Kyowa Kagaku

Zinc oxide: Zinc White No. 1, available from Sakai Kagaku

Carbon black :SAF SEAST 9, available from Tokai Carbon

The product obtained above was subjected to the following tests.

Cured product property test

Hardness: DIN53505

Tensile test: DIN53503

Compression set: ASTM D395, Method B (AS568A214 O-ring)

Corrosion test

Between metal plates (each: 50×50×2 mm), a 214 O-ring was sandwiched, and they were compressed by 3% of the cross section of the O-ring.

The metal plates and the O-ring in the above state were heated in an oven at 250° C. for 70 hours. After the heating, the metal plates were separated from the O-ring, and corrosion of the metal portion sealed with the O-ring was visually observed.

The results are set forth in Table 2.

TABLE 1

| | Comp. | Comp. | Comp. | Comp. | |
|---|---|---|---|---|---|
| | Ex. 1 | Ex. 2 | Ex. 3 | Ex. 4 | Ex. 1 |
| Fluoroeastomer A (phr) | 100 | 100 | 100 | 100 | 100 |
| Crosslinking agent I | 1.4 | 1.4 | 1.4 | 1.4 | 1.4 |
| (phr) | | | | | |
| Zinc oxide (phr) | | 2 | | | |
| Calcium hydroxide (phr) | | | 2 | | |
| Magnesium oxide (phr) | | | | 2 | |
| Hydrotalcite compound | | | | | 2 |
| (phr) | | | | | |
| Carbon black (phr) | 6 | 6 | 6 | 6 | 6 |
| Molding temperature (° C.)/ | 220° C./15 min | | | | |
| Molding time (min) | | | | | |
| Properties of molded | | | | | |
| products | | | | | |
| Hardness (pts) | 72 | 74 | 75 | 75 | 74 |
| Tensile strength (Mpa) | 11.8 | 17.2 | 15.9 | 15.0 | 16.3 |
| Elongation (%) | 140 | 160 | 150 | 160 | 160 |
| Compression set | 20 | 22 | 27 | 27 | 24 |
| (275° C./70 hr) (%) | | | | | |
| Metal corrosion test | | | | | |
| (SUS304) | | | | | |
| 250° C./70 hr | DD | CC | AA | AA | AA |
| 295° C./48 hr | DD | CC | BB | BB | AA |
| Pressure hot water | +0.2 | +2.1 | +1.7 | +1.5 | +0.5 |
| immersion test | | | | | |
| (200° C./70 hr) | | | | | |
| Volume swell (%) | | | | | |

DD: Marked corrosion was observed.
CC: Corrosion was observed.
BB: Very slight corrosion was observed.
AA: Corrosion was not observed.

TABLE 2

| | Comparative | |
|---|---|---|
| | Example 5 | Example 2 |
| Fluoroeastomer B (phr) | 100 | 100 |
| Crosslinking agent II | 1.0 | 1.0 |
| (phr) | | |
| Zinc oxide (phr) | 2 | |
| Hydrotalcite compound | | 2 |
| (phr) | | |
| Carbon black (phr) | 6 | 6 |
| Molding temperature (° C.)/ | 190° C./15 min | |
| Molding time (min) | | |
| Properties of molded | | |
| products | | |
| Hardness (pts) | 76 | 77 |
| Tensile strength (Mpa) | 23.6 | 20.7 |
| Elongation (%) | 160 | 190 |
| Compression set | 45 | 50 |
| (275° C./70 hr) (%) | | |
| Metal corrosion test | | |
| (SUS304) | | |
| 250° C./70 hr | CC | AA |
| 295° C./48 hr | CC | BB |
| Pressure hot water | +17.4 | +1.9 |
| immersion test | | |
| (200° C./70 hr) | | |
| Volume swell (%) | | |

DD: Marked corrosion was observed.
CC: Corrosion was observed.
BB: Very slight corrosion was observed.
AA: Corrosion was not observed.

What is claimed is:

1. A fluoroelastomer composition comprising:
(1) a fluoroelastomer which comprises:
(i) tetrafluoroethylene,
(ii) a perfluoro (C₁-C₅ alkyl vinyl ether) or a perfluoro (C₃-C₁₁ (alkoxyalkyl) vinyl ether), and
(iii) a cyano group-containing perfluorovinyl ether,
(2) a hydrotalcite compound,
(3) a crosslinking agent, and
(4) carbon black.

2. The fluoroelastomer composition as claimed in claim 1, wherein the crosslinking agent is a compound represented by the following formula (I): 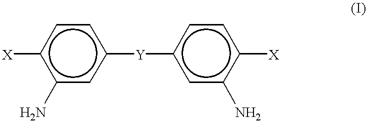
wherein Y is a C₁-C₆ alkylidene group, a C₁-C₁₀ perfluoroalkylidene group, a —SO₂— group, an —O— group, a —C(=O)— group or a carbon-carbon bond to directly bond two benzene rings, and X is a hydroxyl group or an amino group.

3. The fluoroelastomer composition as claimed in claim 1, wherein the crosslinking agent is a compound represented by the following formula (II): 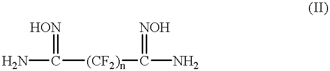
wherein n is an integer of 1 to 10.

4. The fluoroelastomer composition as claimed in claim 1, wherein the crosslinking agent is a compound represented by the following formula (III): 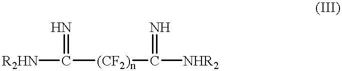
wherein R₂ is H or NH₂, and n is an integer of 1 to 10.

5. The fluoroelastomer composition as claimed in claim 1, wherein the crosslinking agent is a compound represented by the following formula (IV): 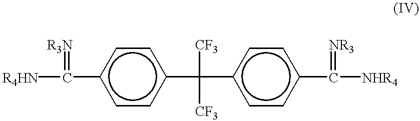
wherein R₃ is OH or H, and R₄ is H or NH₂.
